(19) United States
(12) Patent Application Publication
(10) Pub. No.: US 2007/0016770 A1
(43) Pub. Date: Jan. 18, 2007

(54) System and method for managing the initiation of software programs in an information handling system

(75) Inventor: Aurelian Dumitru, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/183,654

(22) Filed: Jul. 18, 2005

(51) Int. Cl. H04L 9/00

(52) U.S. Cl. 713/164

(57) ABSTRACT

A system and method is disclosed for authenticating the right of a user to user a software application is disclosed. When the user attempts to access a software application, a software authentication program accesses the operating system directory service of the operating system to determine if the user has rights to access the operating system. If the user has rights, the user is permitted to use the software application. If the user does not have rights, the user is not permitted to use the software application. The operating system prevents the operation of software applications that have not been authenticated for use.

### TECHNICAL FIELD

The present disclosure relates generally to computer systems and information handling systems, and, more particularly, to a system and method for managing the initiation of software programs in an information handling system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

In networked computing environments, it is desirable to manage or control the set of software programs that are authorized to execute on the computer network. In this manner, malicious programs and software programs that are unrelated to the business of the organization are not permitted to run on the organization's computer network. A malicious software program may include virus programs and other intrusive programs, such as worms, network sniffers, and key loggers. Software programs that are unrelated to the business of an organization may include photography management tools, music recording tools, and file-sharing programs. Because the execution of unapproved software program consumes information technology resources, the execution of unapproved software programs raises the information technology costs of an organization and is not desirable.

### SUMMARY

In accordance with the present disclosure, a system and method is disclosed for authenticating the right of a software application to execute. In operation, when the user attempts to initiate, download, or otherwise use a software application, software authentication code that is integrated into the software application accesses the directory service or directory services of the operating system to determine if the application has rights to run. If the response from the directory service or director services indicate that the application has the right to execute, the authentication code that is built into the application allows the application to start. If the response is negative, the application is stopped. The software authentication feature may also include a notification function, such as logging initiation attempts to a file for a future audit.

The software authentication function can also be performed by a software authentication utility that runs on an information handling system and monitors attempts by software applications to run. When a software application attempts to start, the utility checks with the operating system directory service or directory services to verify the right of the software application to run. The operating system of the disclosed system and method is configured to prevent the operation of software applications that have not been authenticated for use.

The system and method disclosed herein is technically advantageous because it prevents malicious software in the form of viruses and other software unrelated to the business of the organization from running on a computer system. Because the disclosed system and method requires that all software programs be authenticated, the system and method prevents malicious virus code from executing on the computer system. In addition, the system and method disclosed herein prevents unauthorized personal programs from executing on the computer system. As such, a user could be prevented from running music or photography programs on his business computer.

The system and method disclosed herein can be used to coordinate the right of a software application to execute with the right of a user to start the software application. Thus, the system and the method disclosed herein can serve in a gatekeeper capacity to manage access to software programs by users in a client-server network. According to the system and method disclosed herein, the operating system directory service or directory services of a computer system will include information concerning the authorization rights of each user in the client-server network. Upon recognizing an attempt by a user to access a software program, the authentication utility disclosed herein will access the operating system's directory service or directory services to determine if the user has rights to use the software program. Thus, the utility can be used to limit access by users to the available set of software programs in a client-server network. In addition, the technique disclosed herein provides system administrators with the ability to dynamically change the rights of groups of users in order to grant or deny rights to execute certain software applications. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a logical diagram of the components of the software authentication system and method;

FIG. 2 is a flow diagram of method steps for developing a software application and authenticating the software application for execution on a computer system;

FIG. 3 is a logical diagram of the components of a software authentication system in which a software authentication utility exists as middleware between a software application an operating system; and

FIG. 4A is a flow diagram depicting the method steps for authenticating a software application in an information handling system or computer system having the software architecture of FIG. 1; and

FIG. 4B is a flow diagram depicting the method steps for authenticating a software application in an information handling system or computer system having the software architecture of FIG. 3.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

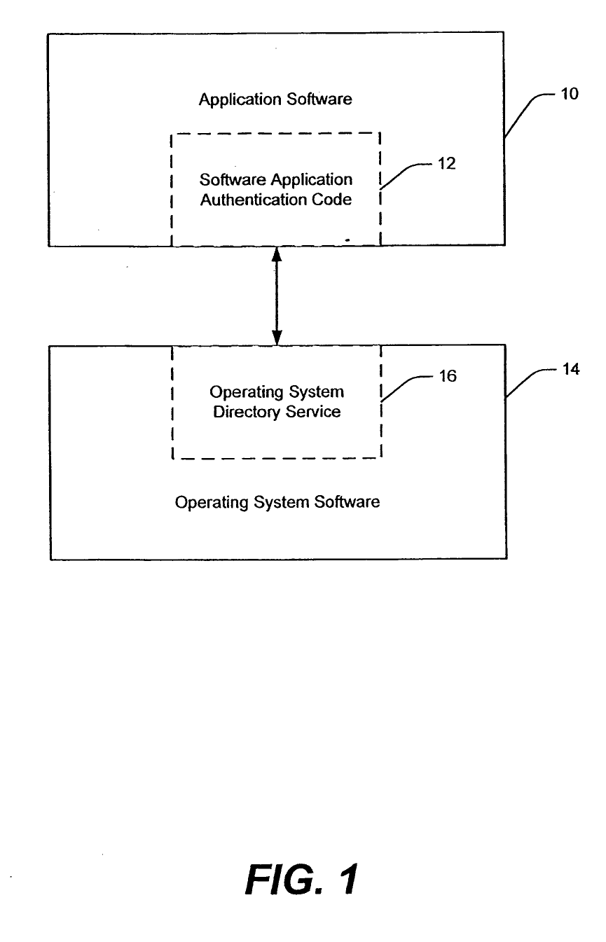

Shown in FIG. 1 is a logical diagram of the components of the software authentication system and method disclosed herein. In operation, an information handling system, including a computer system, will include operating system software 14. The operating system software will include an operating system directory service 16. An operating system directory service is a centralized data repository that reflects the computer resources of the computer network. The operating system directory service catalogs information concerning the resources of a computer network, including information concerning the location, users, passwords, and security for resources of the network. The operating system directory service of a computer network plays an active role in managing the distributed computer resources of a computer network. One example of an operating system directory service is Active Directory® for Windows® 2000, which is a product of Microsoft Corporation of Redmond, Wash. Another example is Novell® eDirectory™ of Novell, Inc. of Waltham, Mass.

Operating system 14 supports the execution of one or more instances of a software application 10. Each instance of software application 10 includes software application authentication code 12. In the example of FIG. 1, software authentication code 12 is integrated into and is delivered with the software application 10. In operation, when an attempt is made to run or initiate the software application, the software authentication code communicates with the operating system directory service of the operating system to determine if the software application may be initiated. The software authentication code may read user data from the directory service to determine if the user associated with the computer system or information handling system has the right to run or initiate the software application. In one example, the software authentication code accesses the operating system directory service and attempts to authenticate the software application each time that the software application is initiated by the user. In another example, the software authentication code only accesses the operating system directory service and attempts to authenticate the software application the first time that the application is initiated by the user. If the software authentication code determines that application may be initiated or, in addition, that the user has rights to run the software, the software application is allowed to run. If the software authentication code determines that the software application may not be initiated or that the user does not have rights to run the software, the software application is prevented from executing on the computer system. Operating system 14 is configured to only support and permit the execution of those software programs that have been authenticated through an instance of software authentication code included in a software application.

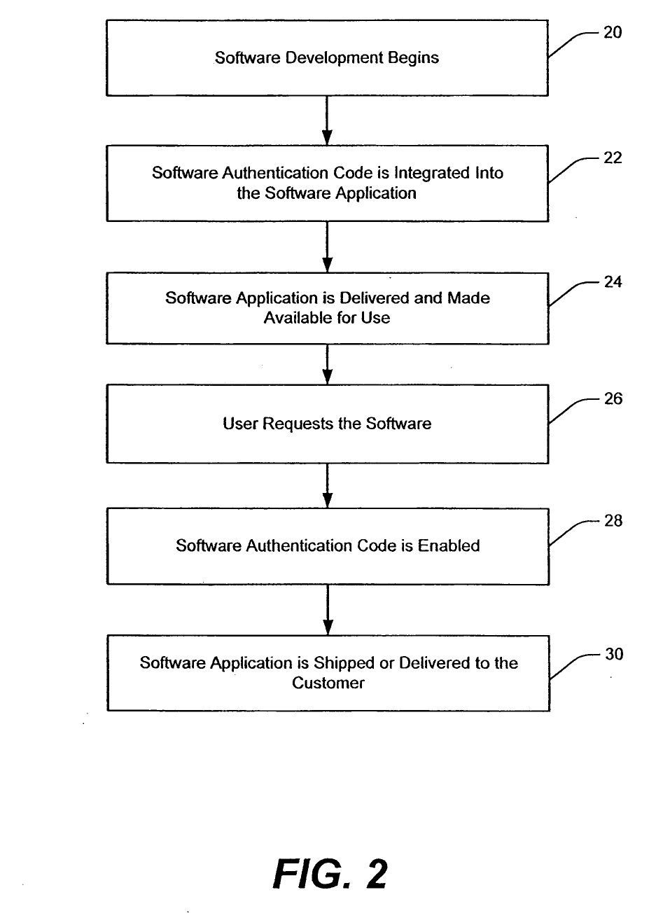

FIG. 2 is a flow diagram of a series of method steps for developing a software application and authenticating the software application for execution on a computer system. At step 20, the development of a software application begins. At step 22, during the development of the software application, the software authentication code of the software application is written into and integrated with the software application. At step 24, the application is made available for distribution. The authentication code is present within the application, but it is not enabled, nor customized. Once the end user or the customer requests the software (step 26), the provider of the software application enables the authentication code at step 28 and eventually customizes it to meet the end user's needs, such as taking certain actions when the right to run is denied. At step 30, the application is now ready to be delivered to the customer or end user.

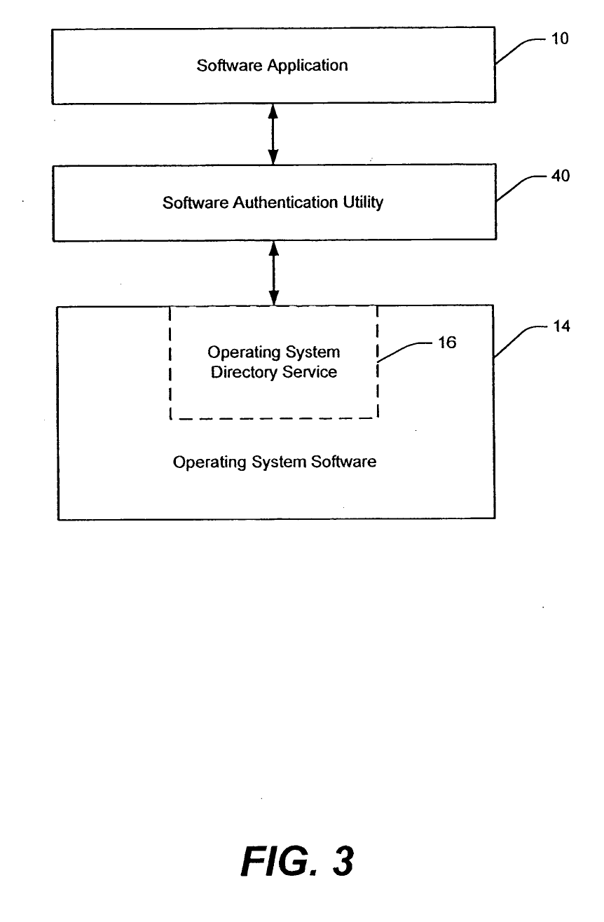

FIG. 3 is a logical diagram of the components of a software authentication system in which a software authentication utility 40 exists as middleware between the software application 10 and the operating system software 14, which includes the operating system directory service 16. Software authentication utility 40 of FIG. 3 performs the same function as the activation protection software 12 of FIG. 1. Software authentication utility 40 operates as a wrapper around software application 10. The use of a software authentication utility is a substitute for integrating software authentication code into the software itself. If a user attempts to initiate software application 10, software authentication utility 40 accesses the operating system directory service to determine if the application is authorized to run and if the user is authorized to run the software application, if applicable. The operating system is configured so that the operating system only supports and permits the execution of those software programs that have been authenticated by the software authentication utility. The authentication process performed by the software authentication utility could be performed each time that an attempt is made to initiate the software application. Alternatively, the authentication process of the software authentication utility could only be performed the first time that a user attempts to initiate the software application. As another example, the software application may be initiated by another software application on the same system or on a different system, such as a system over a network. In this scenario, the utility will check for execution rights on the software application. In addition, authentication may be performed in a manner that is more network-centric.

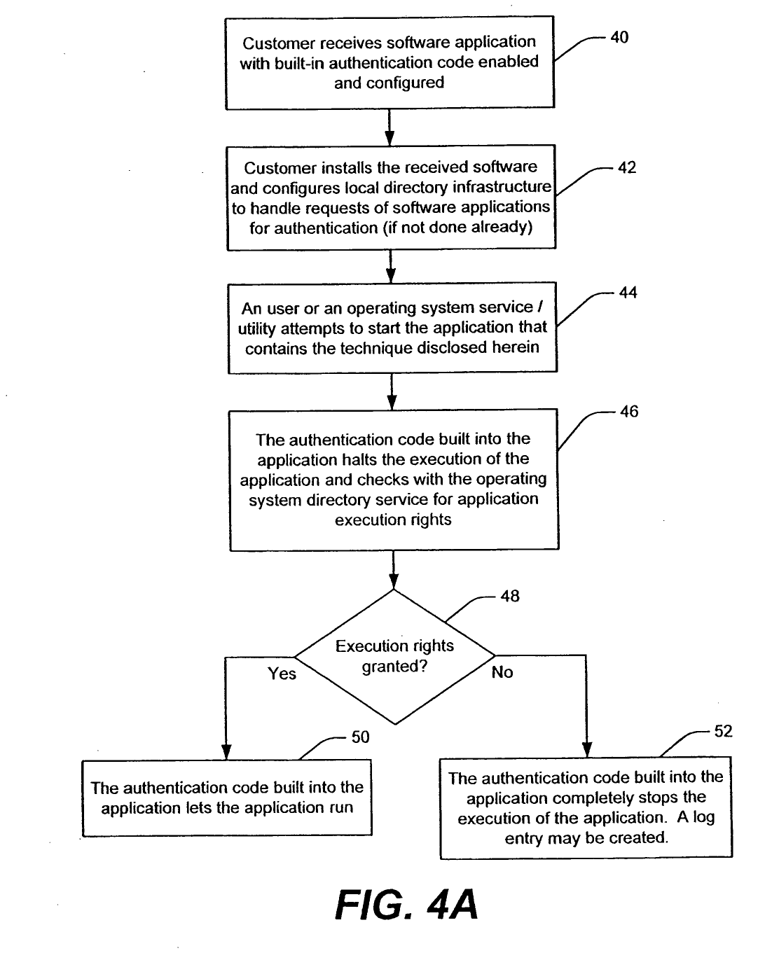

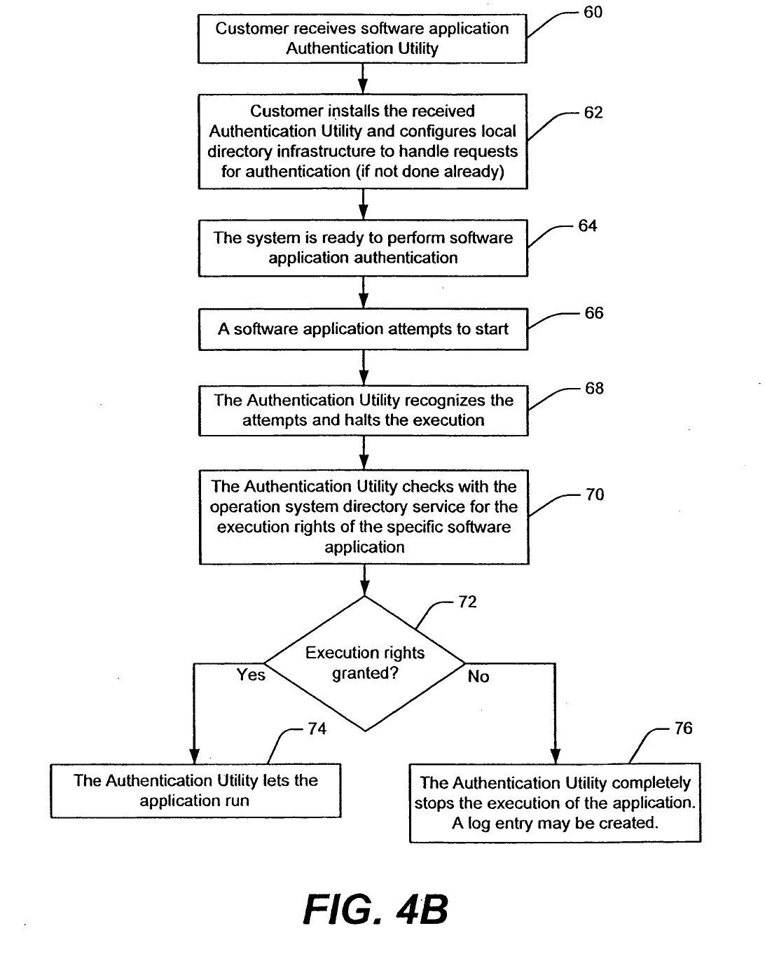

Shown in FIG. 4A is a flow diagram depicting the method steps for authenticating a software application in an information handling system or computer system having the software architecture of FIG. 1. At step 40, a customer receives a software application that includes built-in authentication code that has been enabled and configured. At step 42, the customer installs the software application and, if not previously completed, configures the local directory infrastructure to handle the requests of software applications for authentication. At step 44, the user or an operating system service or utility attempts to start the application having built-in authentication code. The authentication code at step 46 halts the execution of the software application and checks the operating system directory service to determine if the application has the right to execute. The check may also include a check of whether the user of the application software has the right to use the application software. If it is determined at step 48 that the software application has execution rights, the built-in authentication code allows the software application to run at step 50. If it is determined at step 48 that the software application does not have execution rights, the built-in authentication code halts the execution of the application at step 52. As part of step 52, a log entry may be created to record that an unsuccessful attempt was made to start the software application.

Shown in FIG. 4B is a flow diagram depicting the method steps for authenticating a software application in an information handling system or computer system having the software architecture of FIG. 3. At step 60, the customer receives the software application authentication utility. Following the receipt of the software application authentication utility, the customer at step 62 installs the utility and, if not previously done, configures the local directory services infrastructure to handle requests for authentication. At step 64, the system is ready to perform the software authentication function, and, at step 66, the software application attempts to start. The authentication utility recognizes the attempt at step 68 and halts the execution of the software application. At step 70, the authentication utility checks with the operating system directory service for the execution rights of the selected software application. The check may also include a check of whether the user of the application software has the right to use the application software. If it is determined at step 72 that the software application has execution rights, the authentication utility allows the software application to run at step 74. If it is determined at step 72 that the software application does not have execution rights, the built-in authentication code halts the execution of the application at step 76. As part of step 76, a log entry may be created to record that an unsuccessful attempt was made to start the software application.

The software protection scheme described herein prevents malicious code from running on a computer system. A piece of malicious code that has been installed on a user's computer system will not be able to execute on the computer system or computer network. Each computer network is configured so that only authenticated software applications are permitted to execute. In addition, the authentication process involves an authentication utility accessing the operating system directory service to determine if the user who requested the software application is pre-authorized to use the requested software application. The operating system and operating system directory service is configured to force each software application to submit to an authentication routine to confirm that the user who requested or attempted to initiate the software is authorized to use the software.

Although the present disclosure has been described in detail, it should be understood that various changes, substitutions, and alterations can be made hereto without departing from the spirit and the scope of the invention as defined by the appended claims.

What is claimed is:

1. A method for managing the authentication of a software application in a computer system, wherein the computer system comprises an operating system, comprising:
integrating software authentication code into the software application;
recognizing an attempt by a user or another application to initiate the software application;
executing the software authentication code, causing the software authentication code to access the operating system directory service of the operating system; and
wherein the user is permitted to initiate the software application if it is determined that the user has permission to initiate the software application; and
wherein the user is prevented from initiating the software application is it is determined that the user does not have permission to initiate the software application.

2. The method for managing the authentication of a software application in a computer system of claim 1, wherein the operating system is configured to prohibit the operation of software applications that have not been authenticated.

3. The method for managing the authentication of a software application in a computer system of claim 1, wherein the step of executing the software authentication code is performed each time that a user attempts to initiate the software application.

4. The method for managing the authentication of a software application in a computer system of claim 1, wherein the step of executing the software authentication code is performed only the first time that the user attempts to initiate the software application.

5. The method for managing the authentication of a software application in a computer system of claim 1, wherein the operating system directory service includes information sufficient to identify the software applications that the user is able to access.

6. The method for managing the authentication of a software application in a computer system of claim 1, wherein the step of recognizing an attempt by the user to initiate the software application comprises the step of recognizing an attempt by the user to download the software application.

7. The method for managing the authentication of a software application in a computer system of claim 1,
wherein the step of executing the software authentication code is performed each time that a user attempts to initiate the software application;
wherein the operating system is configured to prohibit the operation of software applications that have not been authenticated; and
wherein the step of recognizing an attempt by the user to initiate the software application comprises the step of recognizing an attempt by the user to download the software application.

8. The method for managing the authentication of a software application in a computer system of claim 1,
wherein the step of executing the software authentication code is performed only the first time that the user attempts to initiate the software application;
wherein the operating system is configured to prohibit the operation of software applications that have not been authenticated; and
wherein the step of recognizing an attempt by the user to initiate the software application comprises the step of recognizing an attempt by the user to download the software application.

9. A software architecture for a computer system, comprising:
an instance of a software application, wherein the software application includes authentication code for verifying a user's right to use the software application;
an operating system, wherein the operating system directory service includes a directory service with data sufficient to identify the rights of a user to use certain software applications;
wherein the authentication code is operable to identify an attempt by a user to use the software application and, in response, access the operating system directory service to determine the right of the user to use the software application;
wherein the user is prevented from using the software application if it is determined that the user does not have the right to use the software, and wherein the user is permitted to use the software application if it is determined that the user does have the right to use the software application.

10. The software architecture for a computer system of claim 9, wherein the operating system is configured to prohibit the operation of software applications that have not been authenticated.

11. The software architecture for a computer system of claim 9, wherein the software authentication code determines the right of a user to user the software application each time that the user attempts to initiate the software application.

12. The software architecture for a computer system of claim 9, wherein the software authentication code determines the right of a user to user the software application only the first time that the user attempts to initiate the software application.

13. The software architecture for a computer system of claim 9, wherein the authentication code is operable to identify an attempt by a user to use the software application by downloading the software application and, in response, access the operating system directory service to determine the right of the user to use the software application.

14. The software architecture for a computer system of claim 9,
wherein the operating system is configured to prohibit the operation of software applications that have not been authenticated; and
wherein the software authentication code determines the right of a user to user the software application each time that the user attempts to initiate the software application.

15. The software architecture for a computer system of claim 9,
wherein the operating system is configured to prohibit the operation of software applications that have not been authenticated; and
wherein the software authentication code determines the right of a user to user the software application each time that the user attempts to initiate the software application.

16. A method for managing the authentication of a user to use a software application in a computer system, wherein the computer system comprises an operating system, comprising:
providing a software authentication utility;
recognizing in the software authentication utility an attempt by the user to access the software application;
executing the software authentication utility, causing the software authentication utility to access the operating system directory service of the operating system;
wherein the user is permitted to use the software application if it is determined that the user has permission to use the software application; and
wherein the user is prevented from using the software application is it is determined that the user does not have permission to use the software application.

17. The method for managing the authentication of a user to use a software application in a computer system of claim 16, wherein the operating system is configured to prohibit the operation of software applications that have not been authenticated.

18. The method for managing the authentication of a user to use a software application in a computer system of claim 16, wherein the step of executing the software authentication utility is performed each time that a user attempts to run the software application.

19. The method for managing the authentication of a user to use a software application in a computer system of claim 16, wherein the step of executing the software authentication utility is performed only the first time that a user attempts to run the software application.

20. The method for managing the authentication of a user to use a software application in a computer system of claim 16, wherein the step of recognizing an attempt by the user to access the software application comprises the step of recognizing an attempt by the user to download the software application.
